(19) United States
(12) Patent Application Publication
(10) Pub. No.: US 2025/0390539 A1
(43) Pub. Date: Dec. 25, 2025

(54) SEARCH INTERFACE PRESENTATION METHOD AND APPARATUS, AND DEVICE, MEDIUM AND PRODUCT

(71) Applicant: Beijing Zitiao Network Technology Co., Ltd., Beijing (CN)

(72) Inventors: Wen SONG, Beijing (CN); Lulu WANG, Beijing (CN); Haiying XUE, Beijing (CN)

(21) Appl. No.: 18/877,197

(22) PCT Filed: Jun. 20, 2023
(86) PCT No.: PCT/CN2023/101324

§ 371 Date: Dec. 19, 2024

(30) Foreign Application Priority Data
Jun. 20, 2022 (CN) 202210701629.3

(51) Int. Cl. G06F 16/9532; G06F 3/0485; G06F 16/9538

(52) U.S. Cl. CPC G06F 16/9532; G06F 3/0485; G06F 16/9538

(57) ABSTRACT

The present disclosure relates to a search interface presentation method and apparatus, and a device, a storage medium and a program product. The method comprises: in response to an access request of a current user for a search input interface, presenting the search input interface, wherein the search input interface comprises a search word presentation area, and the search word presentation area is configured for movably presenting a first preset search word at a preset moving speed in a first direction; and in response to a trigger operation for the search input interface, jumping to a search result interface, wherein the search result interface is configured for presenting a search result that matches a target search word, and the target search word is determined on the basis of the trigger operation for the search input interface.

### CROSS-REFERENCE TO RELATED APPLICATIONS

The present application claims priority to and is based on a Chinese application with an application Ser. No. 20/221,0701629.3 and a filing date of Jun. 20, 2022, the aforementioned application is hereby incorporated by reference in its entirety.

### FIELD OF THE INVENTION

The present disclosure relates to the field of computer processing technology, and in particular to a search interface presentation method, apparatus, device, storage medium and program product.

### BACKGROUND

With continuous development of Internet technology, searching is a crucial content in the Internet field. At present, the basic principle of searching is after acquiring a search term, search can be performed according to the search term, and a search result matching the search term can be displayed on the interface.

### DISCLOSURE OF THE INVENTION

Embodiments of the present disclosure provide a search interface presentation method, apparatus, device, storage medium and program product, for movable presentation of a search term on a search interface.

In a first aspect, an embodiment of the present disclosure provides a search interface presentation method, including:
in response to an access request of a current user to a search input interface, presenting the search input interface, wherein the search input interface includes a search term presentation area, and the search term presentation area is configured for movable presentation of a first preset search term along a first direction at a preset moving speed;
in response to a triggering operation on the search input interface, jumping to a search result interface, where the search result interface is configured to present a search result matching a target search term, where the target search term is determined by the triggering operation on the search input interface.

In a second aspect, an embodiment of the present disclosure provides a search interface presentation apparatus, including:
a search interface presentation module, configured to, in response to an access request of a current user to a search input interface, present the search input interface, wherein the search input interface includes a search term presentation area, and the search term presentation area is configured for movable presentation of a first preset search term along a first direction at a preset moving speed;
an interface jumping module, configured to, in response to a triggering operation on the search input interface, jumping to a search result interface, where the search result interface is configured to present a search result matching a target search term, where the target search term is determined by the triggering operation on the search input interface.

In a third aspect, an embodiment of the present disclosure provides an electronic device, the electronic device including:
one or more processors;
a storage device for storing one or more programs;
wherein, the one or more programs, when executed by the one or more processors, cause the one or more processors to implement the search interface presentation method as described in any one of the above-mentioned first aspect.

In a fourth aspect, an embodiment of the present disclosure provides a computer-readable storage medium having a computer program stored thereon, which, when executed by a processor, causes the search interface presentation method as described in any one of the above-mentioned first aspect to be implemented.

In a fifth aspect, an embodiment of the present disclosure provides a computer program product, which includes a computer program or instructions, which, when executed by a processor, causes the search interface presentation method as described in any one of the above-mentioned first aspect to be implemented.

The embodiments of the present disclosure provide a search interface presentation method, apparatus, device, storage medium and program product, the method comprising: in response to an access request of a current user to a search input interface, presenting the search input interface, wherein the search input interface includes a search term presentation area, and the search term presentation area is configured for movable presentation of a first preset search term along a first direction at a preset moving speed; in response to a triggering operation on the search input interface, jumping to a search result interface, where the search result interface is configured to present a search result matching a target search term, where the target search term is determined by the triggering operation on the search input interface.

### DESCRIPTION OF THE DRAWINGS

The above and other features, advantages and aspects of the embodiments of the present disclosure will become more apparent with reference to the accompanying drawings and with reference to the following detailed description. Throughout the drawings, the same or similar reference numerals indicate the same or similar elements. It should be understood that the drawings are schematic and that the components and elements are not necessarily drawn to scale.

FIG. 1 is an architecture diagram of a search interface presentation scenario according to an embodiment of the present disclosure;

FIG. 2 is a flow chart of a search interface presentation method according to an embodiment of the present disclosure;

FIG. 3 is a schematic diagram of a search interface on a client display interface according to an embodiment of the present disclosure;

FIG. 4 is a schematic diagram of an operation of a search term presentation area sliding along a first direction according to an embodiment of the present disclosure;

FIG. 5 is a schematic diagram of an operation of a search term presentation area sliding along a second direction according to an embodiment of the present disclosure;

FIG. 6 is a schematic diagram of a second preset search term presentation area in an embodiment of the present disclosure;

FIG. 7 is a schematic diagram of a search result interface according to an embodiment of the present disclosure;

FIG. 8 is a schematic diagram of a search term input area on a client display interface according to an embodiment of the present disclosure;

FIG. 9 is a schematic structural diagram of a search interface presentation apparatus according to an embodiment of the present disclosure;

FIG. 10 is a schematic structural diagram of an electronic device according to an embodiment of the present disclosure.

### DETAILED DESCRIPTION OF PREFERRED EMBODIMENTS

Embodiments of the present disclosure will be described with reference to the drawings in detail. Although some embodiments of the present disclosure have been illustrated in the drawings, it shall be understood that the present disclosure can be implemented in a variety of manners, and shall not be interpreted as being limited to the embodiments illustrated herein, on the contrary, these embodiments are provided for the purpose of more thoroughly and completely understanding the present disclosure. It shall be understood that the drawings and embodiments of the present disclosure are only used for illustration, and do not constitute a limitation on the present disclosure.

It should be understood that the various steps described in the method embodiments of the present disclosure may be performed in different orders, and/or performed in parallel. Furthermore, the method embodiments can include additional steps, and/or the execution of the illustrated steps may be omitted. The scope of the present disclosure is not limited in this respect.

The term “include” and the variations thereof used in the present disclosure are open-ended terms, that is, “including but not limited to”. The term “based on” means “at least partially based on”. The term “one embodiment” means “at least one embodiment”; the term “another embodiment” means “at least one further embodiment”; the term “some embodiments” means “at least some embodiments”. Related definitions of other terms will be given hereinafter.

It should be noted that concepts such as “first” and “second” mentioned in the present disclosure are only used to distinguish different apparatuses, modules, or units, instead of being used to limit the sequence or interdependence of functions performed by these apparatuses, modules, or units.

It should be noted that the modifiers “one” and “a plurality of” mentioned in the present disclosure are schematic and non-limiting, and those skilled in the art shall understand that, unless otherwise clearly indicated in the context, it should be understood as “one or more”.

The names of messages or information exchanged between the plurality of apparatuses in embodiments of the present disclosure are for illustrative purposes only and are not intended to limit the scope of the messages or information.

In the related art, there are two main ways to obtain a search term. The first way is to display a search input box on a search input interface and acquire the search term input by the user in the search input box. The second way is to directly display a search term on a search input interface, and in response to the user's operation on the search input interface, acquire the search term corresponding to the operation. The search input interface provided in the related art faces a problem of a relatively single presentation style.

The search interface presentation method proposed in an embodiment of the present application will be described in detail below with reference to accompanying drawings.

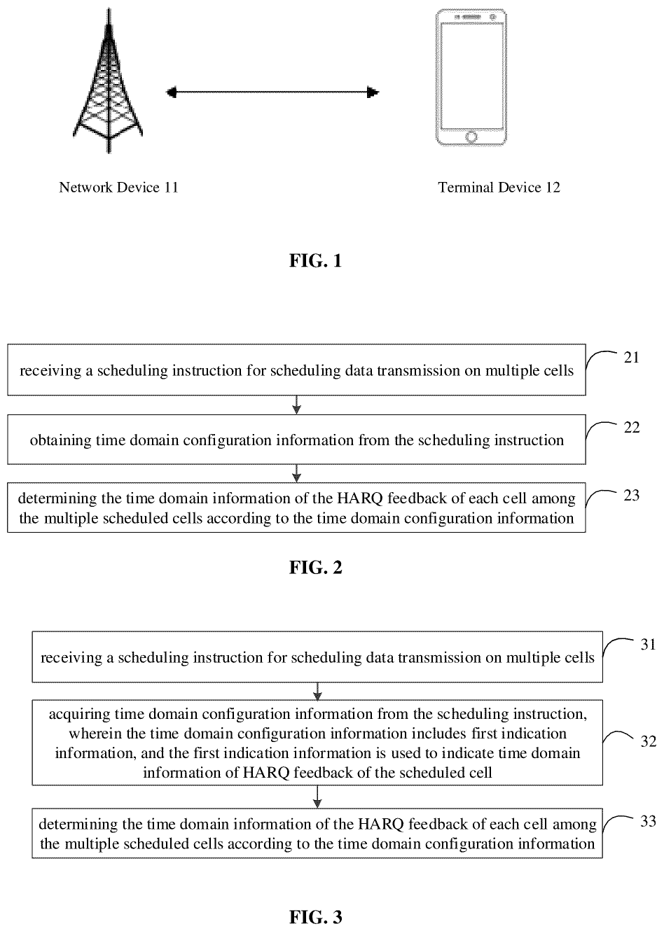

FIG. 1 shows an architecture diagram of a search interface presentation scenario provided by an embodiment of the present disclosure.

As shown in FIG. 1, the architecture diagram may include at least one electronic device 101 on a client side and at least one server 102 on a service side. The electronic device 101 can establish a connection and exchange information with the server 102 through a network protocol such as Hyper Text Transfer Protocol over Secure Socket Layer (HTTPS). Among them, for example: the electronic device 101 can be a mobile terminal, a fixed terminal or a portable terminal, such as a mobile phone, a station, a unit, a device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/camcorder, a positioning device, a television receiver, a radio broadcast receiver, an e-book device, a gaming device, a head-mounted display device or any combination thereof, including accessories and peripherals of these devices or any combination thereof. The server 102 may be a physical server or a cloud server. The server may be a single server or a cluster of servers.

In an embodiment of the present disclosure, a client installed on the electronic device 101 may respond to an access request to a search input interface, upon receiving the access request, the client of electronic device 101 can send the access request to the server 102, the server 102 acquires display contents of the search input interface based on the access request and returns the display contents of the search input interface to the client of electronic device 101. Upon receiving the display contents, the client of electronic device 101 displays the search input interface on a display screen of the electronic device.

Furthermore, after the search input interface is displayed, the client of the electronic device 101 responds to a trigger operation on the search input interface and acquires a target search term based on the trigger operation, generates a search request carrying the target search term, and the electronic device 101 sends the above search request to the server 102. Upon receiving the search request, the server 102 parses it and makes searching based on the above target search term to obtain a search result that matches the target search term, the server 102 feeds back the above search result to the client of the electronic device 101, upon receiving the search result, the client of the electronic device 101 jumps to a search result interface and displays the search result on the search result interface.

In embodiments of the present disclosure, the above-mentioned search interface presentation method can be applied to, but not limited to, various clients deployed with search engines, such as a browser client, a community sharing space client, a short video playback client, a shopping application client, etc. The above-mentioned search interface may include, but not limited to, an interface presented in a search client, for example, including a search input interface and a search result interface, or the like.

FIG. 2 is a flowchart of a search interface presentation method according to an embodiment of the present disclosure. The embodiment is applicable to a case of presenting a search term in a search input interface, the method can be executed by a search interface presentation apparatus, the search interface presentation device can be implemented in software and/or hardware, and the search interface presentation device can be configured in an electronic device.

As shown in FIG. 2, the search interface presentation method provided by the embodiment of the present disclosure mainly includes steps S101-S102.

S101. in response to an access request of a current user to a search input interface, presenting the search input interface, wherein the search input interface includes a search term presentation area, and the search term presentation area is configured for movable presentation of a first preset search term along a first direction at a preset moving speed.

In an embodiment of the present disclosure, the search input interface can be referred to as an interface presented in a search client or a client equipped with a search engine for receiving a search term. The current user can be referred to as a user account that is currently running in the client. The access request may be a data acquisition request carrying a search input interface address.

In an optional implementation, in response to an access request of a current user to a search input interface, may include: when a homepage of the client is set as the search input interface, in response to an operation by the current user to start the client, detecting the access request of the current user to the search input interface, and responding to the access request.

In an optional implementation, in response to an access request of a current user to a search input interface, may include: when a homepage of the client is not the search input interface, a display interface of the client includes a search interface trigger control, and in response to a trigger operation by the current user on the search interface trigger control, detecting the access request of the current user to the search input interface, and responding to the access request.

For example: as shown in FIG. 3, the display interface of the client includes an following interface trigger control 11, a nearby interface trigger control 12, a search interface trigger control 13 and a recommended interface trigger control 14; wherein, the following interface trigger control 11 is configured to respond to the user's trigger operation to display the following interface; the nearby interface trigger control 12 responds to the user's trigger operation to display the nearby interface; the search interface trigger control 13 is configured to respond to the user's trigger operation to display the search input interface; the recommended interface trigger control 14 is configured to respond to the user's trigger operation to display the recommended interface.

In an embodiment of the present disclosure, in response to the current user's triggering operation on the search interface trigger control 13, an access request to the search input interface is acquired, and in response to the access request, a search input interface is displayed in an interface of the client.

In an embodiment of the present disclosure, the search input interface further includes a content stream information presentation area, and the content stream information presentation area is configured to present content stream information, and the content stream information includes at least one media content.

In an embodiment of the present disclosure, as shown in FIG. 3, the search input interface includes a search term presentation area 16, a search term input area 17, and a content flow information presentation area 18. Optionally, the search term presentation area 16 is presented at the top of the search input interface.

In an embodiment of the present disclosure, a plurality of media contents in the content stream information can be displayed in the content stream information presentation area in a list form, or a plurality of media contents in the content stream information can be displayed in the content stream information presentation area in a matrix form, or each screen displays only one media content in the content stream information, and the user can switch the media contents through a sliding gesture. This embodiment does not limit the presentation manner of the content stream information.

In an embodiment of the present disclosure, the media content includes: one of or a combination of audio, video, picture, and text. Furthermore, the content flow information may further include: a publisher of the content flow information, and the number of likes and the number of comments for the content flow information, and so on.

In an embodiment of the present disclosure, the search term presentation area is configured to present at least one first preset search term. The first preset search term may be a topic term or a hot topic term or the like that is recommended to the user.

In an embodiment of the present disclosure, for different users, the first preset search terms presented in the search term presentation area may be the same or different, which is not limited in the embodiment of the present disclosure. For example, the first preset search term presented in the search term presentation area is a hot topic term recommended by the client to the user, the hot topic terms in the same time period may be consistent with each other, so the first preset search term presented in the search term presentation area is the same. For another example, the first preset search terms presented in the search term presentation area for different users are different.

In an embodiment of the present disclosure, the preset moving speed may be a preset fixed value. The fixed value may be set by a client developer or by the current user, and is not specifically limited in embodiments of the present disclosure. The preset moving speed for each first preset search term may be the same, for example, the same preset moving speed is set for each first preset search term. The preset moving speed for each first preset search term may also be different, for example: each first preset search term is set with a different preset moving speed. Alternatively, the moving speeds for some of the search terms may be the same, while being different from the moving speeds for other search terms. As shown in FIG. 3, the preset moving speeds for the first preset search terms in the first row are the same, the preset moving speeds for the first preset search terms in the second row are the same, and the preset moving speeds for the first preset search terms in the first row are different from the preset moving speeds for the first preset search terms in the second row.

In an embodiment of the present disclosure, the first preset search term is movably presented in the search term presentation area along a preset direction at a preset moving speed. Among them, the preset direction may be any direction within 360 degrees. Furthermore, the moving directions for a plurality of first preset search terms may be the same, for example, the plurality of first preset search terms may move from left to right, or from top to bottom. The moving directions for the plurality of first preset search terms may also be different. For example, the plurality of first preset search terms can move from the center to the surroundings, that is, the first preset search terms appear from the center position and disappear at the boundary of the first preset search term presentation area. Alternatively, the plurality of first preset search terms can move from the surrounds to the center, that is, the first preset search terms appear from the boundary of the search term presentation area and disappear at the center of the search term presentation area.

In an embodiment of the present disclosure, the search term presentation area includes at least one search term control, and the movable presentation of the first preset search term at the preset moving speed, may include: movable presentation of the search term control in the search term presentation area at the preset moving speed, wherein a display content of the search term control comprises the first preset search term associated with the search term control.

In an embodiment of the present disclosure, the search term presentation area may include a plurality of search term controls, and a display content on each search term control includes a first preset search term associated with the search term control. In an embodiment of the present disclosure, it is possible to set a preset moving speed and a preset moving direction for the search term control for controlling the search term control to move according to the preset moving speed and the preset moving direction, so that the search term can be movably presented in accordance with the preset moving speed and the preset moving direction.

In an embodiment of the present disclosure, a preset number of search term controls can be cyclically presented in the search term presentation area. Among them, the preset number can be set as desired. Optionally, the preset number can be 10, that is, 10 first preset search term controls are cyclically presented. Specifically, each search term control is associated with a first preset search term, and 10 first preset search terms are cyclically presented in the search term presentation area.

In an embodiment of the present disclosure, a display background of the search term control can be determined by a relative position of the search term control within the search term presentation area; and/or the display background of the search term control can be determined by the first preset search term associated with the search term control.

In embodiments of the present application, the display background of the search term control may be set according to different situations. The display background may be a texture, a color or a picture, which is not limited in the embodiments of the present disclosure.

In an optional implementation, the display background of the search term control can be determined by the relative position of the search term control. Specifically, the display background of a search term control located at the first relative position is set to texture 1, the display background of a search term control located at the second relative position is set to picture 1, the display background of a search term control located at the third relative position is set to texture 2, . . . , and the display background of any search term control can be set in this way. For example, as shown in FIG. 3, the display background of the search term display control associated with search term 3 is texture 1, such as dot texture; the display background of the search term display control associated with search term 5 is texture 2, such as oblique texture.

In an optional implementation, the display background of the search term control can be determined by the search term associated therewith. For example, if the search term is “food”, the display background of the search term control associated with the search term is a food picture; if the search term is “travel”, the display background of the search term control associated with the search term is a landscape picture, and so on.

In an embodiment of the present disclosure, the method may further include: in response to a sliding operation on the search term presentation area along the first direction, acquiring a target moving direction and a target moving speed corresponding to the sliding operation; controlling the first preset search term for movable presentation along the target moving direction at the target moving speed.

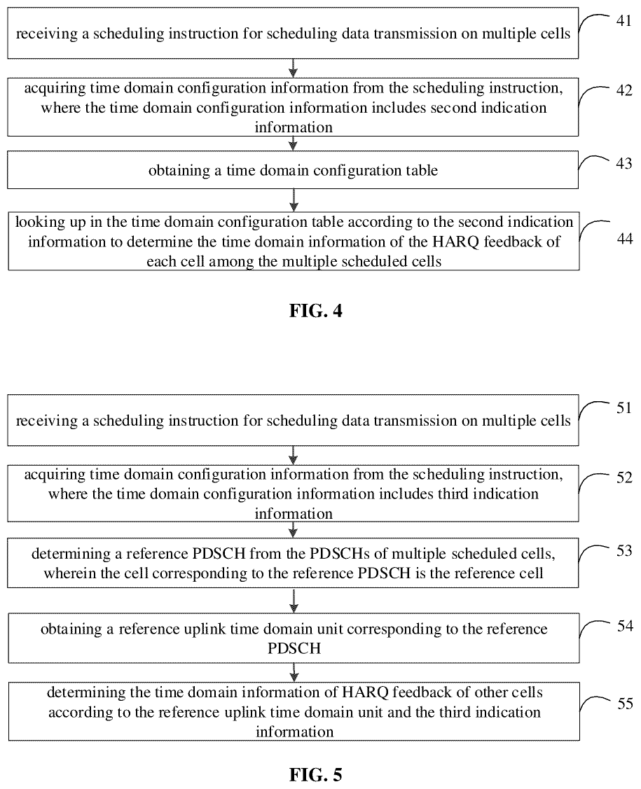

In an embodiment of the present disclosure, the sliding operation along the first direction refers to a sliding operation laterally to the left or a sliding operation laterally to the right. That is, the first preset search term is movably presented in the search term presentation area at a predetermined speed, and the moving direction of the target first preset search term can be determined based on the sliding operation along the first direction. The target moving speed can be determined based on the sliding operation speed along the first direction, that is, the target moving speed can be calculated based on a sliding distance and a sliding duration corresponding to the sliding operation. The sliding distance corresponding to the sliding operation refers to the distance between the starting point and the ending point of the sliding operation, and the sliding duration corresponding to the sliding operation refers to the duration of performing the sliding operation, that is, the time period between a time point corresponding to the starting point of the sliding operation and a time point corresponding to the ending point of the sliding operation. As shown in FIG. 4, in response to sliding operations on the search term presentation area along the first direction at fast and slightly slower two different sliding speeds, the first preset search term in the search term presentation area will be presented at different rates. When the sliding operation along the first direction is performed quickly, the first preset search term in the search term presentation area will be presented at the calculated sliding speed, compared with the sliding operation at a slightly slower speed, the first preset search term in the search term presentation area moves significantly faster, which meets the purpose of the user's sliding operation and facilitates the user to select the target search term.

The movable presentation of the first preset search term along the target moving direction at the target moving speed, may include: if the target moving direction is to the left, then controlling the first preset search term to move to the left at the target moving speed; if the target moving direction is to the right, then controlling the first preset search term to move to the right at the target moving speed. As shown in FIG. 4, in response to a sliding operation on the search term presentation area laterally to the left, a plurality of first preset search terms are controlled to move to the left for presentation.

In an embodiment of the present disclosure, a plurality of first preset search terms may be presented in the search term presentation area in a single row or in multiple rows, which is not limited in embodiments of the present disclosure.

In an embodiment of the present disclosure, when a plurality of first preset search terms are presented in the search term presentation area in a single row, the first preset search terms in the single row can be movably presented based on the control of a sliding operation along the first direction.

In an embodiment of the present disclosure, when a plurality of first preset search terms are presented in the search term presentation area in multiple rows, all the first preset search terms in the search term presentation area can be movably presented based on the control of a sliding operation along the first direction. For example, as shown in FIG. 4, taking two rows of first preset search terms as an example, based on a sliding operation laterally to the left, the preset search terms in the first row and the preset search terms in the second row are controlled to move to the left at the same target moving speed concurrently.

In an embodiment of the present disclosure, when a plurality of first preset search terms are displayed in the search term presentation area in multiple rows, the first preset search terms in a row corresponding to a sliding operation are controlled to be movably presented at a target moving speed, and the first preset search terms in a row corresponding to a non-sliding operation are controlled to be mobile presented at a preset moving speed. For example: taking two rows of first preset search terms as an example, if the row corresponding to the sliding operation is the second row, the first preset search terms in the second row are controlled to be movably presented at the target moving speed, based on the sliding operation along the first direction, meanwhile, the preset search terms in the first row are still presented at the preset moving speed. Among them, the row corresponding to the sliding operation may be referred to as a row where the starting point of the sliding operation is located.

In an embodiment of the present disclosure, the search term moving speed and direction for the search term presentation area can be manually controlled to facilitate users to view search terms and improve user experience.

In an embodiment of the present disclosure, the method may further include: in response to a sliding operation on the search input interface along a second direction, replacing the search term presentation area in the search input interface with at least part of the content stream information presentation area, and expanding the content stream information presentation area.

In an embodiment of the present disclosure, in response to a sliding operation on the search input interface along a second direction, the presentation style and/or presentation position of the search input control can be changed.

In an embodiment of the present disclosure, the sliding operation on the search input interface along the second direction may include an upward sliding operation and a downward sliding operation, and the search term presentation area, the search term input area and the content flow information presentation area are displayed on the search input interface.

As shown in FIG. 5, when the search input interface is slid upward, the search term presentation area will disappear and will not be displayed on the search input interface. Meanwhile, the search term input area also disappears and will not be displayed on the search input interface, and the search control is displayed in the upper right corner of the search input interface. In this way, the content stream information presentation area of the search input interface will be expanded to the entire interface, when the user needs to enter a search term, the user can click the search control to call up the input control.

In response to a downward sliding operation on the search input interface, when the search input interface slides to the top, the search term presentation area and the search term input area will reappear on the search input interface. In some other embodiments, when the search input interface slides back to the top, the search term presentation area will reappear on the search input interface, the search control will still remain displayed in the upper right corner of the search input interface, and the search term input area will no longer appear.

In an embodiment of the present disclosure, the content stream information presentation area may include a plurality of media content presentation modules, and after the replacing the search term presentation area in the search input interface with at least part of the content stream information presentation area, the method further comprises presenting a second preset search term in any one of the media content presentation modules.

In an embodiment of the present disclosure, the number of the second preset search terms is less than the number of the first preset search terms. The second preset search term may be a search term that is completely different from the first preset search term, or may be a part of the first preset search term. Furthermore, the second preset search terms may be a part of first preset search terms that are selected arbitrarily, for example, 4 search terms can be arbitrarily selected from 10 first preset search terms as the second preset search terms. The second preset search terms may be a part of the first preset search terms that are determined therefrom, for example, 4 search terms can be determined from 10 first preset search terms as the second preset search terms. It should be noted that the manner for determining the search terms will not be limited in the embodiment.

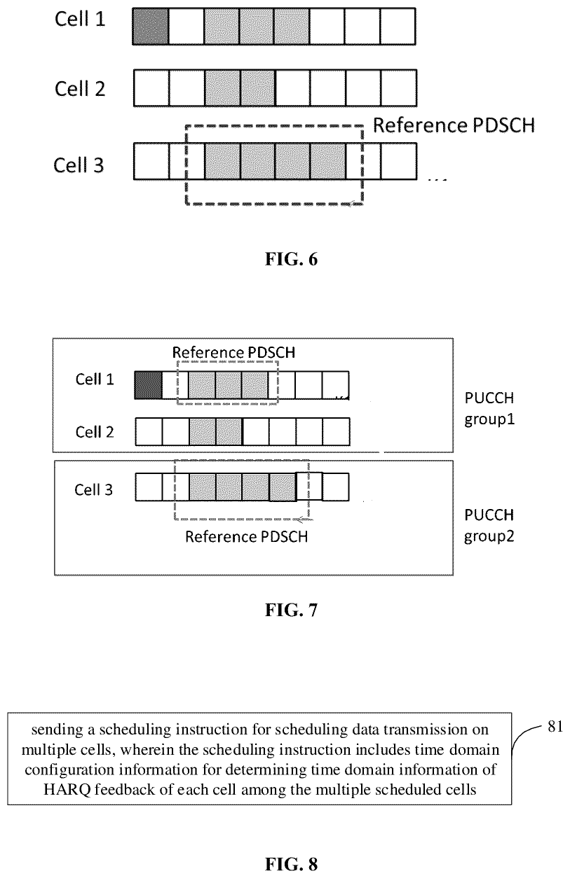

In an embodiment of the present disclosure, as shown in FIG. 6, after the search term presentation area of the search input interface disappears, more media content presentation modules will be displayed in the content stream information presentation area, and any one of the media content presentation modules can be selected to present a second preset search term.

Specifically, after the search input interface performs a downward sliding operation, for example, the content stream information presentation area may display 6 media content presentation modules, and the second preset search term may be presented in any one of the modules.

In an embodiment of the present disclosure, at least one search term control is presented in a media content presentation module, and the display content of the search term control includes a second preset search term associated with the search term control.

Among them, the search term control has the same function as the search term control in the search term presentation area in the above embodiments. For details, please refer to the description in the above embodiments, which will not be repeated in this embodiment.

S102. in response to a triggering operation on the search input interface, jumping to a search result interface, where the search result interface is configured to display a search result matching a target search term, where the target search term is determined by the triggering operation on the search input interface.

In an embodiment of the present disclosure, the triggering operation on the search input interface may include a triggering operation on a search term control associated with a first preset search term in the search term presentation area, and may further include a triggering operation on a search term control associated with a second preset search term in the media content presentation module. Among them, the target search term may be interpreted as the first preset search term associated with the trigger operation, or the second preset search term associated with the trigger operation.

In an embodiment of the present disclosure, as shown in FIG. 7, the search results are presented in the search result interface in the form of a list or a matrix. Furthermore, in response to a vertical sliding operation on the search result interface, the search results matching the target search term are movably presented.

In an embodiment of the present disclosure, in response to a triggering operation on the search input interface, jumping to a search result interface, may include: in response to a trigger operation on the first preset search term, jumping to the search result interface, wherein the target search term is the first preset search term corresponding to the trigger operation; or in response to a triggering operation on a search input control in the search input interface, jumping to the search result interface, wherein the target search term is a search term input through the search input control.

In an embodiment of the present disclosure, in response to a triggering operation on the search input interface, jumping to a search result interface, may include: in response to a trigger operation on the second preset search term, jumping to the search result interface, the target search term is the second preset search term corresponding to the trigger operation.

In an embodiment of the present disclosure, the trigger operation on the search result interface may be a trigger operation on a first preset search term in the search term presentation area, or may be a trigger operation on a second preset search term in the media content presentation module.

Since the first preset search term is associated with the search control, after the user triggers the first preset search term, the search engine will be triggered to operate, the search engine acquires the first preset search term and make searching with the term as the target search term to obtain a search result that matches the first preset search term, then the interface of the client is controlled to jump from the search input interface to the search result interface, and the search result is presented in the search result interface. For example, the first preset search term includes “camping”. After the user selects and clicks on “camping”, the search engine acquires such a search term “camping” and makes searching with “camping” as the target search term to obtain search results matching “camping”, and the search results matching “camping” can be presented on the search result interface.

In an embodiment of the present disclosure, a user may input a target search term in the search term input area on a search input interface, click a search control, trigger the search engine to work, and obtain search results that match the target search term.

In an embodiment of the present disclosure, in response to a triggering operation on the search input control in the search input interface, jumping to the search result interface may include in response to an input operation by the current user on the input control, acquiring a target search term corresponding to the input operation; in response to a triggering operation on the search control, jumping to the search result interface.

In an embodiment of the present disclosure, as shown in FIG. 8, the search term input area may include an input control and a search icon. Among them, the input operation on the input control may include: text information, picture information, etc. input through a virtual keyboard.

In an embodiment of the present disclosure, in response to a triggering operation on the input control, a virtual keyboard can be displayed, and in response to a triggering operation on the virtual keyboard, a target search term input by a user can be acquired.

In an embodiment of the present disclosure, in response to a trigger operation on the input control, a plurality of third preset search terms associated with the user can be displayed, and in response to a trigger operation on the third preset search term, a target search term corresponding to the trigger operation can be acquired.

In an embodiment of the present disclosure, after the target search term corresponding to the input operation is acquired, the target search term is displayed in the input control, and in response to a trigger operation on the search control, the search engine is triggered to work, the search engine acquires the target search term and makes searching with the target search term, to obtain search results that match the target search term, and then controls the client interface to jump from the search input interface to the search result interface, and presents the search results on the search result interface.

In an embodiment of the present disclosure, it is provided a method for users to manually input a search term, which is convenient for a user to input any information the user wants to search for and improves the user experience.

In an embodiment of the present disclosure, after in response to a current user's access request to the search input interface, presenting the search input interface, the method may further include: when the access request of the current user to the search input interface is a first access request, maintaining presentation of the search term presentation area in the search input interface.

In an embodiment of the present disclosure, the first access request may refer to that the current user issues a request to access the search input interface for the first time. When the current user accesses the search input interface for the first time, the search term presentation area, the search term input area and the content flow information presentation area are displayed on the search input interface to facilitate user viewing.

In an embodiment of the present disclosure, the search input interface will provide hot spot information and useful information in the search term presentation area for user selection, making it convenient for users to understand hot spot information and other useful information, enriching user choices, and helping users to select search terms.

In an embodiment of the present disclosure, when the current user accesses the search input interface for the first time and no operation on the search input interface is not responded, the search term presentation area remains presented on the search input interface. In other words, the search term presentation area is presented in the search input interface in a resident form. That is, when the current user accesses the search input interface for the first time and does not perform any operation on the search input interface, the search term presentation area remains displayed on the search input interface and does not disappear.

In an embodiment of the present disclosure, the maintaining presentation of the search term presentation area in the search input interface may include: maintaining presentation of the search term presentation area in the search input interface until a preset condition is triggered, wherein the preset condition comprises displaying a search result interface or receiving a preset trigger operation on the content stream information presentation area.

In an embodiment of the present disclosure, the preset condition is triggering a search engine, entering a search result interface, or receiving a vertical sliding operation of the search input interface.

Specifically, in response to a triggering operation on a search control in the search input interface, jumping to a search result interface in which the search term presentation area is no longer presented. When a vertical downward sliding operation is performed on the search input interface, the search term presentation area disappears, the search term input area disappears, the search control is displayed in the upper right corner of the search input interface, and the disappeared area will be replaced with the content flow information presentation area. The content flow information presentation area fills the entire search input interface, thereby facilitating users to quickly find targets.

In an embodiment of the present disclosure, unlike the preset time condition for not entering the search presentation area for the first time, there does not exist a preset duration for the user entering the search term presentation area in the search input interface for the first time, and the search term presentation area will not disappear, which aims to help the user become familiar with the search input interface more quickly and to better present its hot spots and high-quality contents to the user. After the preset condition is triggered, the search term presentation area disappears, the search term presentation area in the search input interface is replaced by at least part of the content flow information presentation area, and the content flow information presentation area can be expanded to the entire search input interface.

In an embodiment of the present disclosure, after the search input interface is cancelled, in response to a downward sliding operation on the search input interface, the search term presentation area and the search term input area will reappear on the search input interface.

In an embodiment of the present disclosure, the method may further include: when the access request of the current user to the search input interface is a not-first access request, after it is detected that the search term presentation area has been presented for a preset duration, the display of the search term presentation area is cancelled.

In an embodiment of the present disclosure, if the current user is not a first-time access user, the search input interface normally displays the search term presentation area, the search term input area and the content flow information presentation area, after the search input interface has been displayed for a predetermined duration, the display of the search term presentation area will be automatically cancelled.

In an embodiment of the present disclosure, the preset duration for the search term presentation area may be set by the user, or may adopt a default preset duration, which is not specifically limited. For example, the preset duration for the search term presentation area is 3 seconds. When a user opens the search input interface for a non-first time, the search term presentation area can be displayed normally, after the preset duration of 3 seconds, the search term presentation area disappears and is no longer displayed, which means that the user does not need the search term recommended by the search term presentation area.

In an embodiment of the present disclosure, the triggering conditions for the user to cancel the display of the search term presentation area may include: the display time exceeding a preset time, an upward sliding operation of the search input interface, and jumping to the search result interface. Among them, the upward sliding operation of the search input interface has a higher priority, even if the preset duration for the search term presentation area is not reached, reception of an upward sliding operation on the search input interface will still trigger the display of search term presentation area to be cancelled, and the content flow information presentation area containing the target search term on the search result interface will be expanded and displayed.

In an embodiment of the present disclosure, the display of the search term input area is cancelled, and a search control is displayed in the upper right corner of the search input interface.

In one embodiment of the present disclosure, the method may further include: when the access request of the current user to the search input interface is a non-first access request, after it is detected that the search term presentation area has been presented for a preset duration, replacing the search term presentation area in the search input interface with at least part of the content stream information presentation area, and expanding the content stream information presentation area.

In an embodiment of the present disclosure, the number of access requests of the current user to the search input interface can be acquired, if the current user makes the non-first access and the conditions for canceling the display of the search term presentation area are triggered, the search term presentation area in the search input interface will be replaced by a content flow information presentation area, the content flow information presentation area of the search input interface will be further expanded to occupy most of the area of the entire search input interface, thereby facilitating users to find target information.

In an embodiment of the present disclosure, when the current user accesses the search input interface for the non-first time and the conditions for canceling the display of the search term presentation area are triggered, the display of the search term input area is canceled, and a search control is displayed in the upper right corner of the search input interface. The search term input area in the search input interface is replaced with a content flow information presentation area, as shown in FIG. 6.

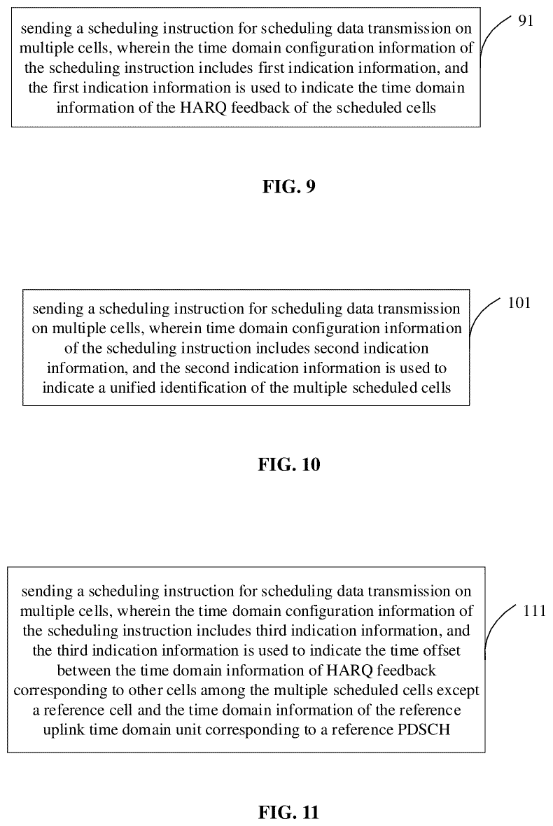

FIG. 9 is a structural diagram of a search interface presentation apparatus in an embodiment of the present disclosure. This embodiment can be applicable to a situation of search interface presentation, the search interface presentation apparatus can be implemented in software and/or hardware, the search interface presentation apparatus can be configured in an electronic device.

As shown in FIG. 9, the search interface presentation device 90 provided in embodiments of the present disclosure mainly includes: a search interface presentation module 91 and an interface jumping module 92.

Among them, the search interface presentation module 91 is configured to, in response to an access request of a current user to a search input interface, present the search input interface, wherein the search input interface includes a search term presentation area, and the search term presentation area is configured for movable presentation of a first preset search term along a first direction at a preset moving speed; the interface jumping module 92 is configured to, in response to a triggering operation on the search input interface, jumping to a search result interface, where the search result interface is configured to present a search result matching a target search term, where the target search term is determined by the triggering operation on the search input interface.

An embodiment of the present disclosure provides a search interface presentation apparatus, which is configured to execute the following process: in response to an access request of a current user to a search input interface, presenting the search input interface, wherein the search input interface includes a search term presentation area, and the search term presentation area is configured for movable presentation of a first preset search term along a first direction at a preset moving speed; in response to a triggering operation on the search input interface, jumping to a search result interface, where the search result interface is configured to present a search result matching a target search term, where the target search term is determined by the triggering operation on the search input interface. The embodiment of the present disclosure solves the problem of search interface presentation style by moving the search term in the search interface and improves the user experience.

In a possible implementation, the search input interface further includes a content stream information presentation area which is configured to present the content stream information, wherein the content stream information comprises at least one media content.

In a possible implementation, the search term presentation area comprises at least one search term control, and the search interface presentation module is specifically configured to movably present the search term control in the search term presentation area at the preset moving speed, wherein a display content of the search term control includes the first preset search term associated with the search term control.

In a possible implementation, a display background of the search term control is determined by a relative position of the search term control within the search term presentation area; and/or wherein, the display background of the search term control is determined by the first preset search term associated with the search term control.

In a possible implementation, the apparatus can further include: a direction and speed acquisition module configured to, for a sliding operation on the search term presentation area along the first direction, acquiring a target moving direction and a target moving speed corresponding to the sliding operation; a search interface presentation module 91 further configured to control the preset search term for movable presentation along the target moving direction at the target moving speed.

In a possible implementation, the search interface presentation module 91 is further configured to, when the access request of the current user to the search input interface is a first access request, maintain presentation of the search term presentation area in the search input interface.

In a possible implementation, the search interface presentation module 91 is further configured to maintain presentation of the search term presentation area in the search input interface until a preset condition is triggered, wherein the preset condition comprises displaying a search result interface or receiving a preset trigger operation on the content stream information presentation area.

In a possible implementation, the search interface presentation module 91 is further configured to, when the access request of the current user to the search input interface is a non-first access request, after it is detected that the search term presentation area has been presented for a preset duration, cancel the presentation of the search term presentation area.

In a possible implementation, the search interface presentation module 91 is further configured to, when the access request of the current user to the search input interface is a non-first access request, after it is detected that the search term presentation area has been presented for a preset duration, replace the search term presentation area in the search input interface with at least part of the content stream information presentation area, and expand the content stream information presentation area.

In a possible implementation, the search interface presentation module 91 is further configured to, in response to a sliding operation on the search input interface along a second direction, replace the search term presentation area in the search input interface with at least part of the content stream information presentation area, and expand the content stream information presentation area.

In a possible implementation, wherein the content stream information presentation area comprises a plurality of media content presentation modules, and after the replacing the search term presentation area in the search input interface with at least part of the content stream information presentation area, the search interface presentation module 91 is further configured to present a second preset search term in any one of the media content presentation modules.

In a possible implementation, the interface jumping module 92 may include: a first interface jumping unit configured to, in response to a trigger operation on the first preset search term, jump to the search result interface, wherein the target search term is the first preset search term corresponding to the trigger operation; or
a second interface jumping unit configured to, in response to a triggering operation on a search input control in the search input interface, jump to the search result interface, wherein the target search term is a search term input through the search input control.

In a possible implementation, the second interface jumping unit may include a target search term acquisition sub-unit configured to, in response to an input operation by the current user on the input control, acquire a target search term corresponding to the input operation; a second interface jumping sub-unit configured to, in response to a triggering operation on the search control, jump to the search result interface.

In a possible implementation, the apparatus may include a control change control configured to, in response to a sliding operation on the search input interface along a second direction, change a presentation style and/or a presentation position of the search input control.

The search interface presentation apparatus provided in embodiments of the present disclosure can execute the steps executed in the search interface presentation method provided in the method embodiments of the present disclosure, and the execution steps and beneficial effects are no longer repeated here.

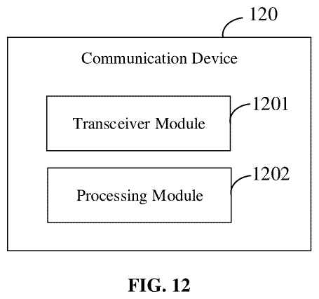

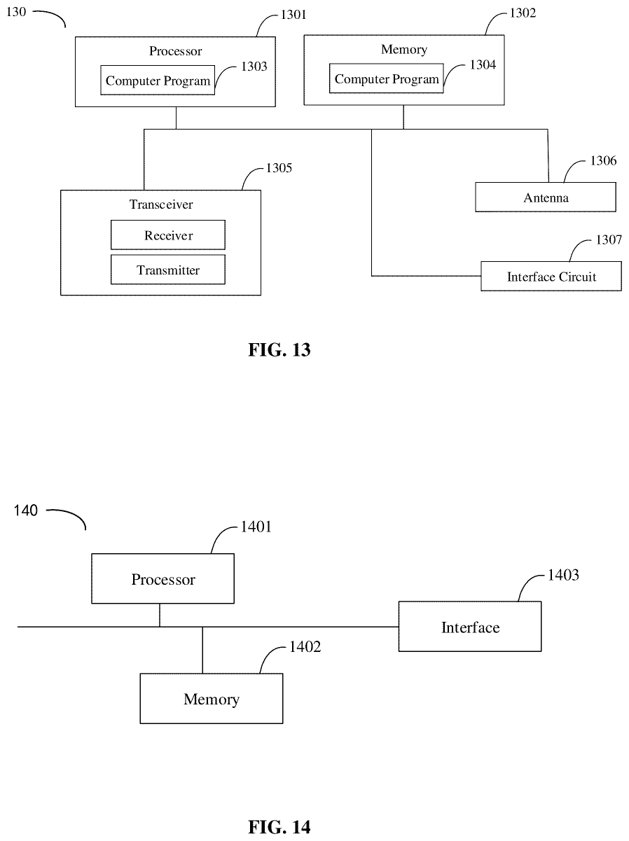

FIG. 10 illustrates a schematic structural diagram of an electronic device provided by embodiments of the present disclosure. Hereinafter specifically referring to FIG. 10, which illustrates the schematic structural diagram applicable to implement electronic device 1000 in the embodiments of the present disclosure. The electronic devices 1000 in the embodiments of the present disclosure may include, but not limited to, mobile terminals such as mobile phones, notebook computers, digital broadcast receivers, PDAs (personal digital assistants), PAD (tablet computers), PMP (portable multimedia players), vehicle-mounted terminals (for example, vehicle-mounted navigation terminals), etc., and fixed terminals such as digital TVs, desktop computers, and the like. The electronic device shown in FIG. 10 is only an example, and should not impose any restriction on the functions and application scopes of the embodiments of the present disclosure.

As shown in FIG. 10, the electronic device 1000 can include a processing apparatus (such as a central processing unit, a graphics processor, etc.) 1001, which can perform various appropriate actions and processes according to a program stored in a Read Only Memory (ROM) 1002 or a program loaded into a Random Access Memory (RAM) 1003 from a storage device 1008 to implement the search interface presentation method according to embodiments of the present disclosure. In the RAM 1003, various programs and data required for the operation of the electronic device 1000 are also stored. The processing device 1001, ROM 1002 and RAM 1003 are connected to each other through a bus 1004. An input/output (I/O) interface 1005 is also connected to the bus 1004.

Generally, the following devices can be connected to the I/O interface 1005: an input device 1006 including, for example, touch screen, touch pad, keyboard, mouse, camera, microphone, accelerometer, gyroscope, etc.; an output device 1007 such as Liquid Crystal Display (LCD), speakers, vibrators, etc.; a storage device 1008 including a magnetic tape, a hard disk, etc.; and a communication device 1009. The communication device 1009 may allow the electronic device 1000 to communicate with other devices wirelessly or in wired so as to exchange data. Although an electronic device 1000 with various devices is shown in FIG. 10, it should be understood that it is not required to implement or have all the devices shown. More or fewer devices may alternatively be implemented or provided.

Particularly, according to embodiments of the present disclosure, the process described above with reference to the flowchart can be implemented as a computer software program. For example, an embodiment of the present disclosure includes a computer program product including a computer program carried on a computer readable medium, the computer program containing program code for executing the method shown in the flowchart. In such an embodiment, the computer program can be downloaded and installed from the network through the communication device 1009, or installed from the storage device 1008 or from the ROM 1002. When executed by the processing device 1001, the computer program carries out the above-mentioned functions defined in the method of the embodiment of the present disclosure.

It should be noted that the above-mentioned computer-readable medium in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or equipment, or any combination of the above. More specific examples of computer-readable storage media may include, but not limited to, an electrical connection with one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium that contains or stores a program that can be used by or in combination with an instruction execution system, device, or equipment. In this disclosure, the computer-readable signal medium may include a data signal propagated in baseband or as a part of a carrier wave, in which computer-readable program codes are carried. This propagated data signal can take many forms, including, but not limited to, electromagnetic signals, optical signals, or any suitable combination of the above. The computer-readable signal medium can also be any computer-readable medium other than the computer-readable storage medium, which can send, propagate, or transmit the program for use by or in connection with the instruction execution system, apparatus, or device. The program codes contained in the computer-readable medium can be transmitted by any suitable medium, including but not limited to: electric wire, optical cable, RF (radio frequency), etc., or any suitable combination of the above.

In some embodiments, the client and the server can communicate by using any currently known or future developed network protocol such as HTTP (HyperText Transfer Protocol), and can be interconnected with any form or medium of digital data communication (e.g., communication network). Examples of communication networks include a local area network (“LAN”), a wide area network (“WAN”), an internet network (e.g., the Internet) and end-to-end network (e.g., ad hoc end-to-end network), as well as any currently known or future developed networks.

The above-mentioned computer-readable medium may be included in the electronic device; or it can exist alone without being loaded into the electronic device.

The above-mentioned computer-readable medium carries one or more programs, which, when executed by a terminal device, cause the terminal device to, in response to an access request of a current user to a search input interface, present the search input interface, wherein the search input interface includes a search term presentation area, and the search term presentation area is configured for movable presentation of a first preset search term along a first direction at a preset moving speed; in response to a triggering operation on the search input interface, jump to a search result interface, where the search result interface is configured to display a search result matching a target search term, where the target search term is determined by the triggering operation on the search input interface.

Optionally, the one or more programs, when executed by a terminal device, cause the terminal device to perform other steps in the above embodiments.

Computer program codes for performing the operations of the present disclosure can be written in one or more programming languages or a combination thereof, including object-oriented programming languages such as Java, Smalltalk, and C++, as well as conventional procedural programming languages such as “C” language or similar programming languages. The program codes can be completely executed on the user's computer, partially executed on the user's computer, executed as an independent software package, partially executed on the user's computer and partially executed on the remote computer, or completely executed on the remote computer or server. In a case related to remote computers, the remote computers can be connected to the user computers through any kind of networks, including Local Area Network (LAN) or Wide Area Network (WAN), or can be connected to external computers (for example, through the Internet with Internet service providers).

The flowcharts and block diagrams in the drawings illustrate the architecture, functions, and operations of possible embodiments of systems, methods, and computer program products according to various embodiments of the present disclosure. In this regard, each block in the flowchart or block diagram may represent a module, a program segment, or a part of the code, which contains one or more executable instructions for implementing specified logical functions. It should also be noted that in some alternative implementations, the functions labeled in the blocks may also occur in a different order than those labeled in the drawings. For example, two blocks shown in succession can actually be executed substantially in parallel, and sometimes they can be executed in the reverse order, depending on the functions involved. It should also be noted that each block in the block diagram and/or flowchart, and the combination of blocks in the block diagram and/or flowchart, can be realized by a dedicated hardware-based system that performs specified functions or operations, or can be implemented by a combination of dedicated hardware and computer instructions.

The units described in the embodiments of this disclosure can be realized by software or hardware. In some cases, the name of the unit does not limit the module itself.

The functions described above herein can be at least partially performed by one or more hardware logic components. For example, without limitation, exemplary types of hardware logic components that can be used may include: field programmable gate array (FPGA), application specific integrated circuit (ASIC), application specific standard product (ASSP), system on chip (SOC), complex programmable logic device (CPLD) and so on.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium may include, but not limited to, electronic, magnetic, optical, electromagnetic, infrared, or semiconductor systems, devices or equipment, or any suitable combination of the foregoing. More specific examples of machine-readable storage medium may include electrical connections based on one or more wires, portable computer disks, hard disks, random access memories (RAM), read-only memories (ROM), erasable programmable read-only memories (EPROM or flash memories), optical fibers, compact disk read-only memories (CD-ROMs), optical storage devices, magnetic storage devices, or any suitable combination of the above.

According to one or more embodiments of the present disclosure, the present disclosure provides a search interface presentation method, comprising: in response to an access request of a current user to a search input interface, presenting the search input interface, wherein the search input interface includes a search term presentation area, and the search term presentation area is configured for movable presentation of a first preset search term along a first direction at a preset moving speed; in response to a triggering operation on the search input interface, jumping to a search result interface, where the search result interface is configured to present a search result matching a target search term, wherein the target search term is determined by the triggering operation on the search input interface.

According to one or more embodiments of the present disclosure, the present disclosure provides a search interface presentation method, wherein the search input interface further comprises a content stream information presentation area which is configured to present the content stream information, wherein the content stream information comprises at least one media content.

According to one or more embodiments of the present disclosure, the present disclosure provides a search interface presentation method, wherein the search term presentation area comprises at least one search term control, and the movable presentation of the first preset search term at the preset moving speed comprises: movable presentation of the search term control in the search term presentation area at the preset moving speed, wherein a display content of the search term control comprises the first preset search term associated with the search term control.

According to one or more embodiments of the present disclosure, the present disclosure provides a search interface presentation method, wherein a display background of the search term control is determined by a relative position of the search term control within the search term presentation area; and/or wherein, the display background of the search term control is determined by the first preset search term associated with the search term control.

According to one or more embodiments of the present disclosure, the present disclosure provides a search interface presentation method, in response to a triggering operation on the search input interface, jumping to a search result interface, may further include: in response to a trigger operation on the first preset search term, jumping to the search result interface, wherein the target search term is the first preset search term corresponding to the trigger operation; or in response to a triggering operation on a search input control in the search input interface, jumping to the search result interface, wherein the target search term is a search term input through the search input control.

According to one or more embodiments of the present disclosure, the present disclosure provides a search interface presentation method, the method may further include: in response to a sliding operation on the search term presentation area along the first direction, acquiring a target moving direction and a target moving speed corresponding to the sliding operation; controlling the first preset search term for movable presentation along the target moving direction at the target moving speed.

According to one or more embodiments of the present disclosure, the present disclosure provides a search interface presentation method, the method further includes: when the access request of the current user to the search input interface is a first access request, maintaining presentation of the search term presentation area in the search input interface.

According to one or more embodiments of the present disclosure, the present disclosure provides a search interface presentation method, wherein the maintaining presentation of the search term presentation area in the search input interface comprises: maintaining presentation of the search term presentation area in the search input interface until a preset condition is triggered, wherein the preset condition comprises displaying a search result interface or receiving a preset trigger operation on the content stream information presentation area.

According to one or more embodiments of the present disclosure, the present disclosure provides a search interface presentation method, the method further includes: when the access request of the current user to the search input interface is a non-first access request, after it is detected that the search term presentation area has been presented for a preset duration, cancelling the presentation of the search term presentation area.

According to one or more embodiments of the present disclosure, the present disclosure provides a search interface presentation method, the method further includes: when the access request of the current user to the search input interface is a non-first access request, after it is detected that the search term presentation area has been presented for a preset duration, replacing the search term presentation area in the search input interface with at least part of the content stream information presentation area, and expanding the content stream information presentation area.

According to one or more embodiments of the present disclosure, the present disclosure provides a search interface presentation method, the method further includes: in response to a sliding operation on the search input interface along a second direction, replacing the search term presentation area in the search input interface with at least part of the content stream information presentation area, and expanding the content stream information presentation area.

According to one or more embodiments of the present disclosure, the present disclosure provides a search interface presentation method, wherein the content stream information presentation area comprises a plurality of media content presentation modules, and after the replacing the search term presentation area in the search input interface with at least part of the content stream information presentation area, the method further comprises: presenting a second preset search term in any one of the media content presentation modules.

According to one or more embodiments of the present disclosure, the present disclosure provides a search interface presentation method, wherein in response to a triggering operation on the search input control in the search input interface, jumping to the search result interface comprises: in response to an input operation by the current user on the input control, acquiring a target search term corresponding to the input operation; in response to a triggering operation on the search control, jumping to the search result interface.

According to one or more embodiments of the present disclosure, the present disclosure provides a search interface presentation method, in response to a sliding operation on the search input interface along a second direction, changing at least one of a presentation style and a presentation position of the search input control.

According to one or more embodiments of the present disclosure, the present disclosure provides a search interface presentation apparatus, which mainly include: a search interface presentation module and an interface jumping module. Among them, the search interface presentation module is configured to, in response to an access request of a current user to a search input interface, present the search input interface, wherein the search input interface includes a search term presentation area, and the search term presentation area is configured for movable presentation of a first preset search term along a first direction at a preset moving speed; the interface jumping module is configured to, in response to a triggering operation on the search input interface, jumping to a search result interface, where the search result interface is configured to present a search result matching a target search term, where the target search term is determined by the triggering operation on the search input interface.

According to one or more embodiments of the present disclosure, the present disclosure provides a search interface presentation apparatus, the search input interface further includes a content stream information presentation area which is configured to present the content stream information, wherein the content stream information comprises at least one media content.

According to one or more embodiments of the present disclosure, the present disclosure provides a search interface presentation apparatus, the search term presentation area comprises at least one search term control, and the search interface presentation module is specifically configured to movably present the search term control in the search term presentation area at the preset moving speed, wherein a display content of the search term control includes the first preset search term associated with the search term control.

According to one or more embodiments of the present disclosure, the present disclosure provides a search interface presentation apparatus, a display background of the search term control is determined by a relative position of the search term control within the search term presentation area; and/or wherein, the display background of the search term control is determined by the first preset search term associated with the search term control.

According to one or more embodiments of the present disclosure, the present disclosure provides a search interface presentation apparatus, the apparatus can further include: a direction and speed acquisition module configured to, for a sliding operation on the search term presentation area along the first direction, acquiring a target moving direction and a target moving speed corresponding to the sliding operation; a search interface presentation module 91 further configured to control the preset search term for movable presentation along the target moving direction at the target moving speed.

According to one or more embodiments of the present disclosure, the present disclosure provides a search interface presentation apparatus, the search interface presentation module 91 is further configured to, when the access request of the current user to the search input interface is a first access request, maintain presentation of the search term presentation area in the search input interface.

According to one or more embodiments of the present disclosure, the present disclosure provides a search interface presentation apparatus, the search interface presentation module 91 is further configured to maintain presentation of the search term presentation area in the search input interface until a preset condition is triggered, wherein the preset condition comprises displaying a search result interface or receiving a preset trigger operation on the content stream information presentation area.

According to one or more embodiments of the present disclosure, the present disclosure provides a search interface presentation apparatus, the search interface presentation module 91 is further configured to, when the access request of the current user to the search input interface is a non-first access request, after it is detected that the search term presentation area has been presented for a preset duration, cancel the presentation of the search term presentation area.

According to one or more embodiments of the present disclosure, the present disclosure provides a search interface presentation apparatus, the search interface presentation module 91 is further configured to, when the access request of the current user to the search input interface is a non-first access request, after it is detected that the search term presentation area has been presented for a preset duration, replace the search term presentation area in the search input interface with at least part of the content stream information presentation area, and expand the content stream information presentation area.

According to one or more embodiments of the present disclosure, the present disclosure provides a search interface presentation apparatus, the search interface presentation module 91 is further configured to, in response to a sliding operation on the search input interface along a second direction, replace the search term presentation area in the search input interface with at least part of the content stream information presentation area, and expand the content stream information presentation area.

According to one or more embodiments of the present disclosure, the present disclosure provides a search interface presentation apparatus, wherein the content stream information presentation area comprises a plurality of media content presentation modules, and after the replacing the search term presentation area in the search input interface with at least part of the content stream information presentation area, the search interface presentation module 91 is further configured to present a second preset search term in any one of the media content presentation modules.

According to one or more embodiments of the present disclosure, the present disclosure provides a search interface presentation apparatus, the interface jumping module 92 may include: a first interface jumping unit configured to, in response to a trigger operation on the first preset search term, jump to the search result interface, wherein the target search term is the first preset search term corresponding to the trigger operation; or
a second interface jumping unit configured to, in response to a triggering operation on a search input control in the search input interface, jump to the search result interface, wherein the target search term is a search term input through the search input control.

According to one or more embodiments of the present disclosure, the present disclosure provides a search interface presentation apparatus, the second interface jumping unit may include a target search term acquisition sub-unit configured to, in response to an input operation by the current user on the input control, acquire a target search term corresponding to the input operation; a second interface jumping sub-unit configured to, in response to a triggering operation on the search control, jump to the search result interface.

According to one or more embodiments of the present disclosure, the present disclosure provides a search interface presentation apparatus, the apparatus may include a control change control configured to, in response to a sliding operation on the search input interface along a second direction, change a presentation style and/or a presentation position of the search input control.

According to one or more embodiments of the present disclosure, the present disclosure provides an electronic device, the electronic device including:
one or more processors;
a storage device for storing one or more programs;
wherein, the one or more programs, when executed by the one or more processors, cause the one or more processors to implement the search interface presentation method as described in any one of the embodiments of the present disclosure.

According to one or more embodiments of the present disclosure, the present disclosure provides a computer-readable storage medium having a computer program stored thereon, which, when executed by a processor, causes the search interface presentation method as described in any one of the embodiments of the present disclosure to be implemented.

According to one or more embodiments of the present disclosure, the present disclosure provides a computer program product, which includes a computer program or instructions, which, when executed by a processor, causes the search interface presentation method as described in any one of the embodiments of the present disclosure to be implemented.

The above description is only a preferred embodiment of the present disclosure and an illustration of the applied technical principles. Those skilled in the art should understand that the scope of the disclosure involved in this disclosure is not limited to the technical solutions formed by the specific combination of the above technical features, but also covers the technical solutions formed by the above technical features or other technical solutions formed by any combination of equivalent features, without departing from the above concept of the present disclosure. For example, a technical solution formed by replacing the above-mentioned features with (but not limited to) technical features with similar functions disclosed in this disclosure.

In addition, while operations are depicted in a particular order, this should not be understood as requiring that the operations be performed in the particular order shown or to be performed in sequential order. Under certain circumstances, multitasking and parallel processing may be advantageous. Likewise, while the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A search interface presentation method, comprising:
in response to an access request to a search input interface, presenting the search input interface, wherein the search input interface includes a search term presentation area, and the search term presentation area is configured for movable presentation of a first preset search term along a first direction at a preset moving speed;
in response to a triggering operation on the search input interface, jumping to a search result interface, where the search result interface is configured to present a search result matching a target search term, wherein the target search term is determined by the triggering operation on the search input interface.

2. The method of claim 1, wherein the search input interface further comprises a content stream information presentation area which is configured to present a content stream information, wherein the content stream information comprises at least one media content.

3. The method of claim 1, wherein the search term presentation area comprises at least one search term control, and the movable presentation of the first preset search term at the preset moving speed comprises:
movable presentation of the search term control in the search term presentation area at the preset moving speed, wherein a display content of the search term control comprises the first preset search term associated with the search term control.

4. The method of claim 3, wherein a display background of the search term control is determined by a relative position of the search term control within the search term presentation area; and/or
wherein, the display background of the search term control is determined by the first preset search term associated with the search term control.

5. The method of claim 1, further comprising:
in response to a sliding operation on the search term presentation area along the first direction, acquiring a target moving direction and a target moving speed corresponding to the sliding operation;
maintaining the first preset search term for movable presentation along the target moving direction at the target moving speed.

6. The method of claim 1, further comprising:
when the access request to the search input interface is a first access request, maintaining presentation of the search term presentation area in the search input interface.

7. The method of claim 6, wherein the maintaining presentation of the search term presentation area in the search input interface comprises:
maintaining presentation of the search term presentation area in the search input interface until a preset condition is triggered, wherein the preset condition comprises displaying a search result interface or receiving a preset trigger operation on a content stream information presentation area.

8. The method of claim 1, further comprising:
when the access request to the search input interface is a non-first access request, after it is detected that the search term presentation area has been presented for a preset duration, cancelling the presentation of the search term presentation area.

9. The method of claim 8, further comprising:
when the access request to the search input interface is a non-first access request, after it is detected that the search term presentation area has been presented for a preset duration, replacing the search term presentation area in the search input interface with at least part of a content stream information presentation area, and expanding the content stream information presentation area.

10. The method of claim 1, further comprising:
in response to a sliding operation on the search input interface along a second direction, replacing the search term presentation area in the search input interface with at least part of a content stream information presentation area, and expanding the content stream information presentation area.

11. The method of claim 9, wherein the content stream information presentation area comprises a plurality of media content presentation modules, and after the replacing the search term presentation area in the search input interface with at least part of the content stream information presentation area, the method further comprises:
presenting a second preset search term in any one of the media content presentation modules.

12. The method of claim 1, wherein in response to a triggering operation on the search input interface, jumping to a search result interface, comprises:
in response to a trigger operation on the first preset search term, jumping to the search result interface, wherein the target search term is the first preset search term corresponding to the trigger operation; or
in response to a triggering operation on a search input control in the search input interface, jumping to the search result interface, wherein the target search term is a search term input through the search input control.

13. The method of claim 12, wherein the search input control comprises an input control and a search control, and in response to a triggering operation on the search input control in the search input interface, jumping to the search result interface comprises:
in response to an input operation on the input control, acquiring a target search term corresponding to the input operation;
in response to a triggering operation on the search control, jumping to the search result interface.

14. The method of claim 13, further comprising:
in response to a sliding operation on the search input interface along a second direction, changing at least one of a presentation style and a presentation position of the search input control.

15. (canceled)

16. An electronic device, comprising:
one or more processors;
a storage device configured to store one or more programs;
wherein the one or more programs, when executed by the one or more processors, cause the one or more processors to implement;
in response to an access request to a search input interface, presenting the search input interface, wherein the search input interface includes a search term presentation area, and the search term presentation area is configured for movable presentation of a first preset search term along a first direction at a preset moving speed;
in response to a triggering operation on the search input interface, jumping to a search result interface, where the search result interface is configured to present a search result matching a target search term, wherein the target search term is determined by the triggering operation on the search input interface.

17. A non-transitory computer-readable storage medium storing a computer program thereon, wherein the computer program, when executed by a processor, causes to implement:
in response to an access request to a search input interface, presenting the search input interface, wherein the search input interface includes a search term presentation area, and the search term presentation area is configured for movable presentation of a first preset search term along a first direction at a preset moving speed;
in response to a triggering operation on the search input interface, jumping to a search result interface, where the search result interface is configured to present a search result matching a target search term, wherein the target search term is determined by the triggering operation on the search input interface.

18. (canceled)

19. (canceled)

20. The electronic device of claim 16, wherein, the one or more programs, when executed by the one or more processors, cause the one or more processors to further implement:
when the access request of the current user to the search input interface is a first access request, maintaining presentation of the search term presentation area in the search input interface, and/or
when the access request of the current user to the search input interface is a non-first access request, after it is detected that the search term presentation area has been presented for a preset duration, cancelling the presentation of the search term presentation area, and/or
when the access request of the current user to the search input interface is a non-first access request, after it is detected that the search term presentation area has been presented for a preset duration, replacing the search term presentation area in the search input interface with at least part of the content stream information presentation area, and expanding the content stream information presentation area.

21. The electronic device of claim 16, wherein in response to a triggering operation on the search input interface, jumping to a search result interface, comprises:
in response to a trigger operation on the first preset search term, jumping to the search result interface, wherein the target search term is the first preset search term corresponding to the trigger operation; or
in response to a triggering operation on a search input control in the search input interface, jumping to the search result interface, wherein the target search term is a search term input through the search input control.

22. The non-transitory computer-readable storage medium of claim 17, wherein, the computer program, when executed by a processor, causes to further implement:
when the access request of the current user to the search input interface is a first access request, maintaining presentation of the search term presentation area in the search input interface, and/or
when the access request of the current user to the search input interface is a non-first access request, after it is detected that the search term presentation area has been presented for a preset duration, cancelling the presentation of the search term presentation area, and/or
when the access request of the current user to the search input interface is a non-first access request, after it is detected that the search term presentation area has been presented for a preset duration, replacing the search term presentation area in the search input interface with at least part of the content stream information presentation area, and expanding the content stream information presentation area.

23. The non-transitory computer-readable storage medium of claim 17, wherein in response to a triggering operation on the search input interface, jumping to a search result interface, comprises:
in response to a trigger operation on the first preset search term, jumping to the search result interface, wherein the target search term is the first preset search term corresponding to the trigger operation; or
in response to a triggering operation on a search input control in the search input interface, jumping to the search result interface, wherein the target search term is a search term input through the search input control.
